(19) United States
(12) Patent Application Publication
(10) Pub. No.: US 2004/0006188 A1
(43) Pub. Date: Jan. 8, 2004

(54) Fluorinated acrylate derivatives having carbonate groups and polymerizable composition comprising same

(76) Inventors: Eunkyoung Kim, Daejeon (KR); Song Yun Cho, Daejeon (KR)

Correspondence Address: David A. Einhorn, Esq., Anderson Kill & Olick, P.C., 1251 Avenue of the Americans, New York, NY, 10020, US

(21) Appl. No.: 10/460,022

(22) Filed: Jun. 11, 2003

(30) Foreign Application Priority Data
Jun. 21, 2002 (KR) 2002-34939

(51) Int. Cl. C08F 118/00

(52) U.S. Cl. 526/245; 526/249; 526/319

(57) ABSTRACT

A polymerizable composition comprising a novel carbonate group-containing acrylate derivative of formula (I) of the present invention is used to prepare a polymer film or molded product having improved compatibility with dyes, high adhesivity to a substrate, low optical loss and low birefringence:

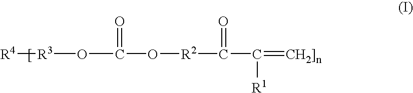

wherein:

n is an integer of 1 to 4;

R¹ is hydrogen or C₁₋₃ alkyl;

R² is —(CH₂)ₐO— or —(CH₂CH₂O)_{b}— (a is an integer of 1 to 20, and b is an integer of 2 to 20);

R³ is an optional substituent selected from the group consisting of —CH₂—, —C₆H₄— and —C₆F₄—; and

R⁴ is C₁₋₁₀ perfluoroalkyl when n=1; when n=2, a bridging group comprising at least one linking moiety selected from the group consisting of C₁₋₃ perfluoroalkylene, C₁₋₃ perfluoroalkyleneoxy and —CF₂CFCl—; or when n=3 or 4, a bridging group comprising

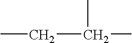

and said linking moiety.

### FIELD OF THE INVENTION

The present invention relates to novel photo- or thermal-curable fluorinated acrylate derivatives having carbonate groups and a polymerizable composition comprising same as a polymerizable monomer, which can be used to prepare a polymer film or molded product having improved compatibility with dyes, high adhesivity to a substrate, low optical loss and low birefringence.

### BACKGROUND OF THE INVENTION

Transparent polymers suitable for optical waveguide and interconnection applications are generally required to have such properties as high thermostability, low optical loss at optical communication wavelengths of 1.3 and 1.55 μm, amenability to fine tuning of birefringence, applicability to various substrates, good stacking property and dimensional flexibility, among which the low optical loss is most important.

In order to reduce the optical loss, there has been widely used a method which involves replacing hydrogen atoms of C—H bonds present in conventional materials with heavier elements such as deuterium and fluorine, thereby shifting the corresponding absorption bands to higher wavelengths and reducing the absorption at 1.3 and 1.55 μm.

For example, NTT of Japan reported that an optical device prepared with various copolymers of deuterated methylmethacrylate and deuterated perfluoromethacrylate monomers as cladding and core materials shows a very low optical loss of 0.08 dB/cm at 1.3 μm (see [Electron. Lett., 1991, 27, 1342]). However, such polymethylmethacrylate resin has a low glass transition temperature (Tg) of about 100° C. and, further, exhibits unsatisfactory optical loss at the optical communication wavelength of 1.55 μm.

Further, perfluorinated polyimide polymers developed by NTT, Japan, have been reported to have good thermal and processing properties (see [Electron. Lett., 1993, 29, 269] and [Macromolecules, 1993, 26, 419]); however, they exhibit poor light polarization due to its large birefringence and high optical loss.

Fluorinated polyimide polymers (trade name: Ultradel 9000D series) commercially available from Amoco Chemicals, USA, are capable of forming an optical device by simple photocuring methods (see [J. Appl. Phys., 1994, 76, 2505]). However, they show relatively high optical losses of 0.5 and 0.9 dB/cm at 1.3 and 1.55 μm, respectively, and high birefringences.

Dow Chemical has reported a perfluorocyclobutane aromatic ether polymer which exhibits improved thermal and gap filling properties as well as a low optical loss property of below 0.25 dB/cm at 1.55 μm (see [Electron. Lett., 1997, 33, 518]). However, a thin film thereof has poor adhesivity to a substrate, e.g., a silicon wafer, or glass, quartz or polycarbonate plate, due to its low polarity.

The fluorinated polyarylene ether reported in [Macromolecules, 1997, 30, 2767] is a low dielectrical material having improved thermal and mechanical properties, and low water adsorption, but cannot be used in the process of forming a multilayered optical device due to its poor resistance to chemicals.

In addition, U.S. Pat. Nos. 4,985,473, 6,306,563 and 6,323,361 disclose a composition containing perfluorinated acrylate derivatives having epoxy or unsaturated groups and an optical device using same. A thin layer thereof, however, shows poor adhesivity toward a substrate, low compatibility with dyes and poor transparency.

### SUMMARY OF THE INVENTION

Accordingly, it is a primary object of the present invention to provide a novel compound which is capable of forming a polymer film or molded product having improved compatibility with dyes, high adhesivity to a substrate, low optical loss and low birefringence.

It is another object of the present invention to provide a polymerizable composition containing same.

In accordance with one aspect of the present invention, there is provided a novel compound of formula (I):

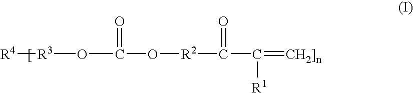

wherein:

n is an integer of 1 to 4;

R¹ is hydrogen or C₁₋₃ alkyl;

R² is —(CH₂)ₐO— or —(CH₂CH₂O)_{b}— (a is an integer of 1 to 20, and b is an integer of 2 to 20);

R³ is an optional substituent selected from the group consisting of —CH₂—, —C₆H₄— and —C₆F₄—; and

R⁴ is C₁₋₁₀ perfluoroalkyl when n=1; when n=2, a bridging group comprising at least one linking moiety selected from the group consisting of C₁₋₃ perfluoroalkylene, C₁₋₃ perfluoroalkyleneoxy and —CF₂CFCl—; or when n=3 or 4, a bridging group comprising

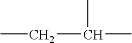

and said linking moiety.

### BRIEF DESCRIPTION OF THE DRAWINGS

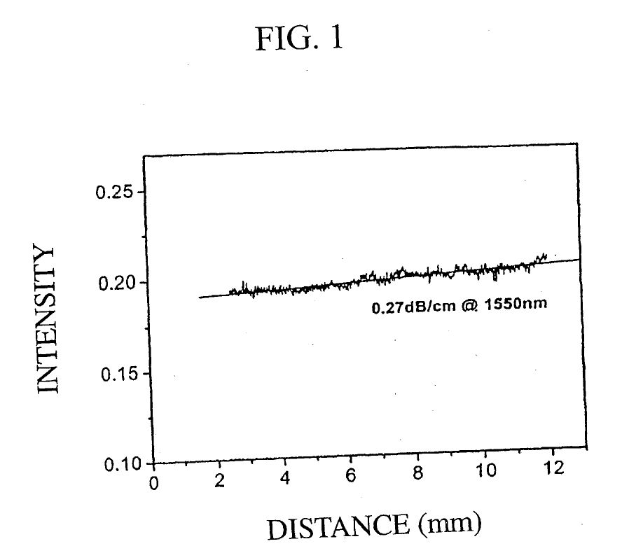

The above and other objects and features of the present invention will become apparent from the following description of the invention, when taken in conjunction with the accompanying drawing, FIG. 1, which shows the optical loss at 1.55 μm of the inventive polymer film obtained in Example 38.

### DETAILED DESCRIPTION OF THE INVENTION

The fluorinated acrylate derivative of formula (I) of the present invention is characterized by having one or two polar carbonate groups, and when n=2, R⁴ may further comprise a linking moiety of CH₂—CH(OH).

The inventive compound of formula (I) may be prepared by reacting a compound of formula (II) with a compound of formula (III) in an organic solvent in the presence of a base, as shown in Reaction Scheme A:

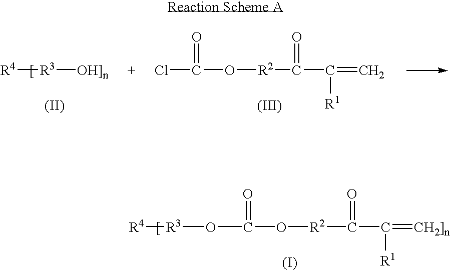

wherein R¹, R², R³, R⁴ and n have the same meanings as defined in formula (I) above.

The reaction in Reaction Scheme A may be conducted at a temperature ranging from 0 to 150° C. for 30 minutes to 14 days, using the fluorinated alcohol of formula (II) in an amount ranging from 1 to 5 equivalents based on the amount of the chloroformate derivative of formula (III).

The compounds of formulae (II) and (III) are commercially available or they may be prepared in accordance with the conventional procedures disclosed in Japanese Publication Patent No. 1998-130205. Representative examples of the base include triethylamine, diisopropylamine, tetramethyl ethylenediamine, pyridine, tetrabutylammonium bromide, benzyltrimethylammonium chloride, KOH, K₂CO₃ and the like. Suitable for use in this reaction is an organic solvent such as chloroform, methylene chloride, tetrahydrofuran, N-methylpyrrolidone, methylsulfoxide, N,N-dimethylacetamide, 1,4-dioxane, ethanol, methanol, benzene, ethyleneglycol dimethyl ether and acetonitrile.

The present invention also includes within its scope a polymerizable composition comprising the compound of formula (I) in combination with a polymerization initiator as essential ingredients.

The polymerizable composition of the present invention may comprise the polymerizable monomer of formula (I) in an amount ranging from 1 to 99% by weight based on the weight of the composition and it may further comprise additional polymerizable compounds, which are known in the art, including hydrocarbon monomers, or oligomers or polymers thereof containing unsaturated or functional groups such as vinyl, vinyl ether, acryl, methacryl, and epoxy. Representative examples thereof may include styrene, alpha-methylstyrene, divinylbenzene, polyethylene glycol monomethyl ether monoacrylate, polyethylene glycol monomethyl ether monomethacrylate, butylmethacrylate, polyethylene glycol diacrylate, polyethylene glycol dimethacrylate, tripropylene glycol diacrylate and fluorides thereof in an amount ranging from 1 to 95% by weight based on the weight of the composition.

The polymerizable composition of the present invention may comprise at least one polymerization initiator selected from conventional photo- and thermal-polymerization initiators in an amount ranging from 0.01 to 20% by weight based on the weight of the composition.

Suitable photo-polymerization initiators may include benzophenone, 2-ethylanthraquinone, phenanthraquinone, 1,2-benzanthraquinone, 2,3-benzanthraquinone, 2,3-dichloronaphthoquinone, benzyl dimethyl ketal, benzoin methyl ether, benzoin ethyl ether, benzoin isobutyl ether, benzoin phenyl ether, methyl benzoin, 1-hydroxycyclohexylphenylketone, 2,2-dimethoxy-2-phenylacetophenone, α,α-diethyloxyacetophenone, α,α-dimethyloxy-α-hydroxyacetophenone, 1-[4-(2-hydroxyethoxy)phenyl]-2-hydroxy-2-methyl-propan-1-one, 2-methyl-1-[4-(methylthio)phenyl]-2-morpholino-propan-1-one, 2-benzyl-2-dimethylamino-1-(4-morpholinophenyl)-butan-1-one, poly {1-[4-(1-methylvinyl)phenyl]-2-hydroxy-2-methyl-propan-1-one}, [4-(4-methylphenylthio)-phenyl]phenylmethanone, dicampherquinone, quinoxaline derivatives, bicinal polyketaldonyl derivatives, and iodate and sulfonate containing BF₄, PF₆, SbF₆ and SO₃CF₃ anions.

Examples of thermal-polymerization initiators that can be used in the present invention are conventional organic peroxide-based, azo-based and pinacole-based compounds, e.g., benzoyl peroxide, p-chlorobenzoyl peroxide, methylethylketone peroxide, cyclohexanone peroxide, tert-butyl perbenzoate, tert-butylperoxy-2-ethylhexoate, tert-butyl hydroperoxide, cumene hydroperoxide, di-tert-butylperoxide, di-sec-butylperoxide, dicumylperoxide, 2,5-dimethyl-2,5-di(t-butylperoxide)-hexane, 1,3-bis(t-butylperoxyisopropyl)benzene, 1,3-bis(cumylperoxyisopropyl)benzene, 2,4-dichlorobenzoylperoxide, caprylylperoxide, lauroylperoxide, t-butylperoxyisobutyrate, hydroxyheptylperoxide, di-t-butyldiperphthalate, t-butylperacetate, 1,1,-di(t-butylperoxy)-3,3,5-trimethylcyclohexane, 2,2′-azobisisobutyronitrile, 2,2′-azobis(2,4-dimethylvaleronitrile), (1-phenylethyl)azodiphenylmethane, 2,2′-azobis(4-methoxy-2,4-dimethylvaleronitrile), dimethyl-2,2′-azobis(1-cyclohexanecarbonitrile), 2-(carbamoylazo)-isobutyronitrile, 2,2′-azobis(2,4,4-trimethylpentane), 2-phenylazo-2,4-dimethyl-4-methoxyvaleronitrile, 2,2′-azobis(2-methylpropane) and dicamperquinone.

Besides the polymerization initiator, the inventive composition may further comprise various optical additives such as crosslinking agents, nonlinear optical compounds, antioxidants, photochromic compounds, photostabilizers, UV absorbents, viscosity enhancing agents, photosensitive agents, flatting agents and adhesion enhancers depending upon the intended application.

Examples of the additives are crosslinking agents such as diallyl-1,3,5-triazine-2,4,6-(1H,3H,5H)-trion, triallyl-1,3,5-triazine-2,4,6-(1H,3H,5H)-trion, tri(2-acryloyloxy)isocyanurate, 1,3,5-tri(2-methacryloxyethyl)-s-triazine and alkylthiols; nonlinear optical compounds such as diarylethenes, spirobenzopyranes, azobenzenes, stilbene-based derivatives and polymers thereof; antioxidants such as tetrakis[methylene-(3,5-di-tert-butyl-1,4-hydroxyhydrocinnamate)]methane, sulfides, organoboron compounds, organophosphorous compounds and N,N′-hexamethylenebis(3,5-di-tert-butyl-4-hydroxyhydrocinnamamide); photostabilizers such as poly[N,N′-bis(2,2,6,6,-tetramethyl-4-piperidinyl)-1,6-hexamethylenediamine-co-2,4-dichloro-6-morpholino-1,3,5-s-triazine]; UV absorbents such as benzotriazoles and hydroxybenzophenone; viscosity increasing agents such as benzoin, benzoin methyl ether, benzoin ethyl ether, benzoin isopropyl ether, diphenyl disulfide, tetramethyl thiuram monosulfide, azobisisobutyronitrile, 2-methyl-anthraquinone and 2-ethyl-anthraquinone; and photochromic compounds such as 1,2-bis(2-methylbenzo[b]thiophen-3-yl)hexafluorocyclopentene, derivatives thereof and spirobenzopyrane.

In accordance with the present invention, a polymer film or molded product may be prepared by coating the inventive polymerizable composition on a support material (e.g., silicon wafer, glass plate) or placing it in a mold, and then heating (at a temperature of room temperature to 130° C.) or irradiating with rays (e.g., ultraviolet rays, visible rays, electronic beams, ionic beams, X-rays, gamma-rays) the coating layer or the mold. Such coating may be performed by a conventional roll, spin, bar, spray or deep coating method, and the thickness of the coated film or molded product may be adjusted in the range of 0.05μ to 3 mm.

The polymer film or molded product thus obtained has improved compatibility with dyes, good adhesivity to a substrate and high chemical resistance, and exhibits low optical loss as well as a reduced birefringence due to its high fluorine content plus network-type crosslinking density. Thus, the inventive polymer film can be advantageously used in forming a multilayered optical device.

The following Examples and Comparative Examples are given for the purpose of illustration only and are not intended to limit the scope of the invention.

In the Examples and Comparative Examples, the characteristics of the polymerizable compositions and the polymer films formed therewith were evaluated in accordance with the following methods.

1. Compatibility with Dye

The phase of a mixture of a sample composition and either a photochromic dye (1,2-bis(6-acetyl-2-methylbenzo[b]thiophene-3-yl)hexafluorocyclopentene(DAH)) or a nonlinear optical dye (Disperse Red 1(DR1): 4-nitro-4′-[ethyl(hydroxyethyl)amino]azobenzene) was observed with the naked eye, followed by examining the state of a sample film derived from the composition also with the naked eye. The observation results were evaluated as follows:

O: the composition mixture is homogeneous, and the film is transparent without phase separation.

Δ: the composition mixture is homogeneous, but the film is not completely transparent with a sign of some phase separation.

X: the composition mixture is not homogeneous.

2. Adhesion Property

A sample film was cut in a checkered pattern at 1 mm intervals. An adhesive test tape was firmly attached to the center of the pattern, removed by a sharp peeling motion, and the state of the pattern was examined. The results were evaluated in the following manner:

++: the area peeled is less than 15% of the pattern area.

+: the area peeled is 15% or more of the pattern area.

3. Optical Loss

Optical loss of a sample film was determined by measuring the transmitted power according to the waveguide length. This method uses a prism to couple the light into the waveguide and two detectors, respectively, to measure the reflected intensity and transmitted intensity.

### PREPARATION EXAMPLE 1

Synthesis of the Compound Disclosed in U.S. Pat. No. 4,985,473

2,2,3,3,4,4-Hexafluoro-1,5-pentanediol(1.00 g) and isocyanatoethyl methacrylate(1.90 g) were dissolved in 50 ml of THF, dibutylthine dilaurate was added thereto, and stirred for 6 hrs. The reaction mixture was washed three-times with water and dried over anhydrous magnesium sulfate, to obtain perfluoropentylurethane dimethacrylate of formula (IV) (yield 95%).

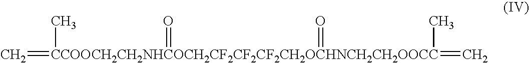

¹H-NMR (CDCl₃) 1.95 (s, 6H), 3.50-3.55 (m, 4H), 4.11-4.26 (m, 4H), 4.52-4.62 (m, 4H), 5.61 (s, 2H), 6.13 (s, 2H).

### PREPARATION EXAMPLE 2

Synthesis of the Compound Disclosed in U.S. Pat. No. 6,306,563

Perfluoro-1,6-hexanediol(1.00 g) was dissolved in 50 ml of methylene chloride, and triethylamine(1.16 g) in 10 ml of methylene chloride was added thereto at 6° C. over a period of 10 min. with stirring. After 10 min, acryloyl chloride(1.04 g) in 10 ml of methylene chloride was added to the solution over a period of 15 min. with stirring, and stirred further at room temperature for 4 hrs. The reaction mixture was washed with saturated aqueous NaHCO₃, the organic layer was washed three-times with water, and then dried over anhydrous magnesium sulfate. The resulting residue was purified by column chromatography (eluent-ethylacetate:hexane=1:10) to obtain perfluorohexanediol diacrylate of formula (V) as a colorless liquid (yield 90%).

CH₂═CHCOOCH₂CF₂CF₂CF₂CF₂CH₂COOCH═CH₂ (V)

¹H-NMR (CDCl₃) 4.83 (m, 4H), 6.13-6.73 (m, 6H).

### EXAMPLES 1 TO 8

Synthesis of the Inventive Compounds

### EXAMPLE 1

Fluorinated triethyleneglycol of formula (IIa)(Exfluor, 1.00 g) was dissolved in 50 ml of THF, and triethylamine(0.89 g) in 10 ml of THF was added thereto at 6° C. over a period of 10 min. with stirring. After 10 min, ethyleneglycol monomethacrylchloroformate of formula (IIIa) (prepared in accordance with the method disclosed in Japanese Publication Patent No. 1998-130205, 1.70 g) in 10 ml of THF was added to the solution over a period of 15 min. with stirring, and stirred further at room temperature for 4 hrs. The reaction mixture was washed with saturated aqueous NaHCO₃, the organic layer was washed three-times with water, and then dried over anhydrous magnesium sulfate, to obtain perfluoroethyleneoxy carbonate dimethacrylate of formula (Ia) (yield 85%).

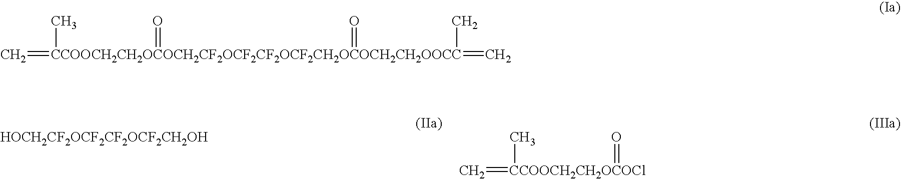

¹H-NMR (CDCl₃) 1.95 (s, 6H), 4.38-4.57 (m, 12H), 5.61 (s, 2H), 6.14 (s, 2H).

### EXAMPLES 2 TO 8

The procedure of Example 1 was repeated while changing the reactants, catalysts, solvents, temperature and time as shown in Table 1, to obtain various acrylate derivatives.

TABLE 1

| | | Catalyst | Solvent | Temp | Time | Yield |
|---|---|---|---|---|---|---|
| | Reactants (g) | (g) | (ml) | (° C.) | (min) | (%) |
| Ex. | The compound of formula (IIIa) (3.5) | Pyridine | THF | 6 | 12 | 80 |
| 2 | HOCH₂(CF₂)₃CH₂OH (2) | (1.3) | (80) | | | |
| | ¹H-NMR of product (CDCl₃) 1.92(s,6H), 4.25(t,4H), 4.57(t,4H), 4.82-5.01(m,4H), | | | | | |
| | 5.56(s,2H), 6.07(s,2H) | | | | | |
| Ex. | The compound of formula (IIIa) (3) | Diiso- | Chloro- | 25 | 8 | 77 |
| 3 | HOCH₂CF₂O(CF₂CF₂O)₈(CF₂O)₄CF₂CH₂OH (2) | pylamine | form | | | |
| | | (1.5) | (80) | | | |
| | ¹H-NMR of product (DMSO-d₆) 1.91(s,6H), 4.25-4.78(m,12H), 5.57(s,2H), 6.07(s,2H) | | | | | |
| Ex. | The compound of formula (IIIa) (3) | Triethyl | Methylene | 6 | 4 | 75 |
| 4 | CF₃(CF₂)₆CH₂OH (3) | amine | chloride | | | |
| | | (6) | (50) | | | |
| | ¹H-NMR of product (CDCl₃) 1.93(s,6H), 4.26(t,2H), 4.57(t,2H), 4.83-5.02(m,2H), | | | | | |
| | 5.57(s,1H), 6.07(s,1H) | | | | | |
| Ex. | The compound of formula (IIIa) (3) | Triethyl | THF | 30 | 24 | 70 |
| 5 | HOC₆F₄C(CF₃)₂C₆F₄OH (4) | amine | (80) | | | |
| | | (1.8) | | | | |
| | ¹H-NMR of product (CDCl₃) 1.95(s,6H), 4.23(t,4H), 4.55(t,4H), 5.55(s,2H), | | | | | |
| | 6.05(s,2H) | | | | | |
| Ex. | CH₂═CHCOO(CH₂CH₂O)ₘCOCl | Triethyl | THF | 10 | 12 | 76 |
| 6 | (m = 7˜8) (5) | amine | (90) | | | |
| | HOCH₂(CF₂CFCl)₃CF₂CH₂OH (3) | (2) | | | | |
| | ¹H-NMR of product (DMSO-d₆) 1.91(s,6H), 3.57-4.48(b,56H), 4.82-5.01(m,4H), | | | | | |
| | 5.61(s,2H), 6.10(s,2H) | | | | | |
| Ex. | The compound of formula (IIIa) (5) | Triethyl | THF | 6 | 36 | 70 |
| 7 | Tetraol | amine | (90) | | | |
| | {HOCH₂CH(OH)CH₂OCH₂(CF₂CFCl)₃CF₂CH₂OCH₂CH(OH)CH₂OH} | (2) | | | | |
| | (7) | | | | | |
| | ¹H-NMR of product (DMSO-d₆) 1.90(s,12H), 4.03-4.16(m,8H), 4.20-4.26(m,8H), | | | | | |
| | 4.55-4.73(m,14H), 5.55(s,4H), 6.05(s,4H) | | | | | |
| Ex. | CH₂═CHCOO(CH₂CH₂O)₃COCl (8) | Pyridine | THF | 5 | 10 | 75 |
| 8 | HOCH₂(CF₂CFCl)₃CF₂CH₂OCH₂CH(OH)CH₂OH (6) | (2.5) | (80) | | | |

¹H-NMR of product (DMSO-d₆) 1.70(s,3H), 1.92(s,6H), 3.58-3.65(m,18H),
3.84-3.87(m,6H), 4.01-4.25(m,10H), 4.45-4.48(m,7H), 4.57-4.73(m,3H),
4.82-5.01(m,2H), 5.32(s,1H), 5.56(s,2H), 6.06(s,2H)

### EXAMPLES 9 TO 29, AND COMPARATIVE EXAMPLES 1 AND 2

Preparation of Polymerizable Compositions

1) one or more polymerizable compounds selected from the acrylate derivatives obtained in Preparation Examples 1 and 2, and Examples 1 to 8, and commercially available hydrocarbons, 2) a polymerization initiator, 3) an optional crosslinking agent, and 4) an optional dye were mixed in respective amounts as shown in Table 2 and stirred at room temperature over a period ranging from 5 min. to 24 hrs. to prepare polymerizable compositions. The compatibilities with dye of the respective compositions thus prepared are shown in Table 2.

TABLE 2

| | Components (weight %) | | | | Compatibility |
|---|---|---|---|---|---|
| | polymerizable | Crosslinking | Polymerization | | with |
| | compounds | agent*¹ | initiator*² | Dye*³ | dye |
| Ex.9 | Ex.1 (23) | 15 | Irgacure184 (2) | — | — |
| | Pr.Ex.1 (45) | | | | |
| | Pr.Ex.2 (15) | | | | |
| Ex.10 | Ex.1 (23) | 15 | Irgacure184 (2) | DAH | Δ |
| | Pr.Ex.1 (33) | | | (7) | |
| | Pr.Ex.2 (20) | | | | |
| Ex.11 | Ex.2 (30) | 15 | Irgacure184 (3) | DAH | Δ |
| | Comp.A*⁴ (20) | | Darocurl173 (2) | (10) | |
| | Ex.3 20 | | | | |
| Ex.12 | Ex.4 (50) | 15 | Irgacure184 (5) | DAH | ◯ |
| | Ex.3 (5) | | | (5) | |
| | Pr.Ex.2 (20) | | | | |
| Ex.13 | Ex.5 (45) | 10 | Irgacure184 (5) | DAH | ◯ |
| | Comp.B*⁵ (15) | | | (7) | |
| | Pr.Ex.2 (18) | | | | |
| Ex.14 | Ex.1 (65) | 10 | Irgacure184 (2) | DR1 | Δ |
| | Pr.Ex.2 (13) | | | (10) | |
| Ex.15 | Ex.1 (55) | 15 | Irgacure184 (5) | DR1 | ◯ |
| | Pr.Ex.1 (10) | | | (5) | |
| | Ex.6 (10) | | | | |
| Ex.16 | Ex.1 (55) | 10 | Irgacure184 (5) | DR1 | ◯ |
| | Pr.Ex.1 (10) | | | (5) | |
| | Ex.7 (15) | | | | |
| Ex.17 | Ex.1 (55) | 10 | Irgacure184 (3) | DAH | ◯ |
| | Pr.Ex.1 (10) | | Darocurl173 (2) | (7) | |
| | Ex.8 (13) | | | | |
| Ex.18 | Ex.2 (50) Comp.C*⁶ (13) Comp.D*⁷ (25) | — | 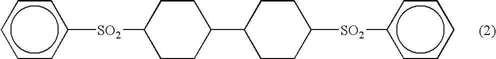 | DAH (10) | Δ |
| Ex.19 | Ex.1 (53) Ex.3 (10) Ex.4 (25) | — | 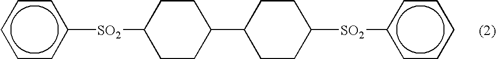 | DAH (10) | ◯ |
| Ex.20 | Ex.1 (30) | — | Darocurl173 (5) | DAH | ◯ |
| | Ex.4 (55) | | | (10) | |
| Ex.21 | Ex.1 (60) | — | Darocurl173 (5) | DAH | ◯ |
| | Ex.7 (25) | | | (10) | |
| Ex.22 | Ex.1 (15) | — | Darocurl173 (5) | DAH | ◯ |
| | Ex.2 (75) | | | (5) | |
| Ex.23 | Ex.1 (13) | — | Darocurl173 (5) | DAH | ◯ |
| | Pr.Ex.2 (75) | | | (7) | |
| Ex.24 | Ex. 1 (5) | — | Darocurl173 (5) | DAH | ◯ |
| | Pr.Ex.2 (80) | | | (10) | |
| Ex.25 | Ex.1 (85) | — | Darocurl173 (5) | DAH | ◯ |
| | | | | (10) | |
| Ex.26 | Ex.1 (60) | — | Darocurl173 (5) | — | — |
| | Pr.Ex.1 (10) | | | | |
| | Pr.Ex.2 (25) | | | | |
| Ex.27 | Ex.1 (55) | — | Darocurl173 (5) | DAH | ◯ |
| | Pr.Ex.1 (10) | | | (10) | |
| | Pr.Ex.2 (20) | | | | |
| Ex.28 | Ex. 1 (60) | — | AIBN (5) | DR1 | ◯ |
| | Ex.2 (10) | | | (10) | |
| | Ex.7 (15) | | | | |
| Ex.29 | Ex.1 (55) | — | AIBN (5) | DR1 | ◯ |
| | Pr.Ex.1 (10) | | | (10) | |
| | Pr.Ex.2 (20) | | | | |
| C.Ex. | Pr.Ex.1 (68) | — | Darocurl173 (2) | DAH | X |
| 1 | Pr.Ex.2 (20) | | | (10) | |
| C.Ex. | Pr.Ex. 1 (80) | — | Darocurl173 (5) | — | — |
| 2 | Pr.Ex.2 (15) | | | | |

Foot Note:
*¹crosslinking agent: triallyl-1,3,5-triazine-2,4,6-(1H,3H,5H)-trione (Aldrich)
*²polymerization initiator: Irgacure 184 (Ciba-Geigy, 1-hydroxycyclohexylphenylketone), Darocurl173 (Ciba-Geigy,
α,α-dimethyloxy-α-hydroxyacetophenone), AIBN (Aldrich, azobisisobutyronitrile), the compound used in
Examples 18 and 19 (one prepared by the method disclosed in U.S. Pat. No. 4,918,046)
*³dye: DAH (1,2-bis(6-acetyl-2-methylbenzo[b]thiophene-3-yl)hexafluoro-cyclopentene prepared by the method
disclosed in Korean Publication Patent No. 2000-14038),
DR1 (Aldrich, 4-nitro-4′-[ethyl(2-hydroxyethyl)amino]azobenzene)
*⁴Compound A: C₁₀F₂₁SO₂N(CH₃)CH₂CH₂OOC(CH₃)C═CH₂ (one prepared by the method disclosed in U.S. Pat. No. 4,985,473)
*⁵Compound B: CH₂═CClCO₂CH₂(CF₂CFCl)₂CF₂CH₂OC(O)CCl═CH₂ (one prepared by the method disclosed in U.S. Pat. No. 6,323,361)
*⁶Compound C: HCF₂(CF₂)₅CH₂O(CH₂)₄OCH═CH₂ (one prepared by the method disclosed in U.S. Pat. No. 6,133,472)
*⁷Compound D:

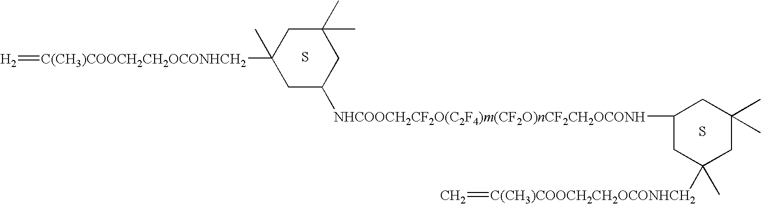

(one prepared by the method disclosed in U.S. Pat. No. 4,985,473)

As shown in Table 2, the compositions containing the inventive acrylate derivatives having carbonate groups as polymerizable materials (Examples 9 to 29) exhibit good compatibility with dye, while the compositions containing the conventional acrylate derivatives only (Comparative Examples 1 and 2), poor compatibility with dye.

### EXAMPLES 30 TO 36, AND COMPARATIVE EXAMPLES 3 AND 4

Preparation of Polymer Films using Polymerizable Compositions

### EXAMPLE 30

The composition prepared in Example 9 was filtered through a 0.45 μm syringe filter. The filtrate was spin coated on a silicon wafer and exposed to ultraviolet rays for 10 min. under a nitrogen atmosphere, followed by post-baking at 100° C. for 10 min, to prepare a transparent polymer film. The film thus obtained showed good adhesivity (++) to the silicon wafer.

### EXAMPLE 31

The procedure of Example 30 was repeated except that the composition prepared in Example 28 was used and thermal-cured at 80° C. for 15 min, to prepare a transparent polymer film. The film thus obtained exhibited good adhesivity (++) to the silicon wafer.

### EXAMPLES 32 TO 36, AND COMPARATIVE EXAMPLES 3 AND 4

The photo-curing procedure of Example 30 or the thermal-curing procedure of Example 31 was repeated using the compositions shown in Table 3, to prepare respective polymer films. The adhesion properties of the films thus obtained were shown in Table 3.

TABLE 3

| | Composition | Curing method | Adhesion property |
|---|---|---|---|
| Ex. 32 | Ex. 21 | Photo-curing | ++ |
| Ex. 33 | Ex. 22 | Photo-curing | ++ |
| Ex. 34 | Ex. 23 | Photo-curing | ++ |
| Ex. 35 | Ex. 24 | Photo-curing | ++ |
| Ex. 36 | Ex. 28 | Thermal-curing | ++ |
| Comp. Ex. 3 | Comp. Ex. 1 | Photo-curing | + |
| Comp. Ex. 4 | Comp. Ex. 2 | Photo-curing | + |

As shown in Table 3, the polymer films obtained using the inventive compositions show better adhesion properties than the comparative layers.

### EXAMPLES 37 AND 38

Multilayered Polymer Films for Optical Waveguide Prepared using Polymerizable Compositions

### EXAMPLE 37

Polymeric EPU12-450(ZenPhotonix) having a low birefringence was is coated on a silicon substrate and photo-cured to form a lower cladding layer. Then, the composition obtained in Example 26 was coated on the cladding layer by the method of Example 30 to prepare a multilayered film for optical waveguide.

The polymer film thus obtained has a very low optical loss of 0.35 dB/cm at 1.55 μm and a low birefringence of 0.0014, wherein the birefringence was measured by a prism coupling method.

### EXAMPLE 39

The procedure of Example 37 was repeated using the composition obtained in Example 27 in place of the composition obtained in Example 26 to prepare a multilayered polymer film for optical waveguide.

The polymer thin layer thus prepared has a very low optical loss of 0.27 dB/cm at 1.55 μm and a low birefringence of 0.001, wherein the birefringence was measured by a prism coupling method. The optical loss thereof is shown in FIG. 1.

As the above results show, the polymerizable composition comprising the novel carbonate group-containing acrylate derivative of the present invention can be advantageously used in the preparation of a polymer film or molded product having a low optical loss and birefringence besides improved compatibility with dyes, high adhesivity to a substrate and high chemical resistance.

While the invention has been described with respect to the specific embodiments, it should be recognized that various modifications and changes may be made by those skilled in the art to the invention which also fall within the scope of the invention as defined by the appended claims.

What is claimed is:

1. A fluorinated acrylate derivative of formula (I): 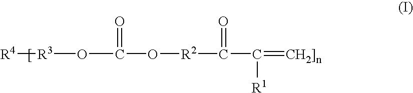
wherein:
n is an integer of 1 to 4;
R¹ is hydrogen or C₁₋₃ alkyl;
R² is —(CH₂)ₐO— or —(CH₂CH₂O)_{b}— (a is an integer of 1 to 20, and b is an integer of 2 to 20);
R³ is an optional substituent selected from the group consisting of —CH₂—, —C₆H₄— and —C₆F₄—; and
R⁴ is C₁₋₁₀ perfluoroalkyl when n=1; when n=2, a bridging group comprising at least one linking moiety selected from the group consisting of C₁₋₃ perfluoroalkylene, C₁₋₃ perfluoroalkyleneoxy and —CF₂CFCl—; or when n=3 or 4, a bridging group comprising 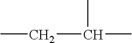
and said linking moiety.

2. A process for preparing the compound of claim 1 which comprises reacting a compound of formula (II) with a compound of formula (III) in an organic solvent in the presence of a base: 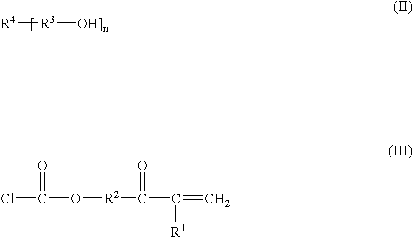
wherein:
R¹, R², R³, R⁴ and n have the same meanings as defined in claim 1.

3. The process of claim 2, wherein the reaction is conducted at a temperature ranging from 0 to 150° C. for 30 minutes to 14 days using a base selected from the group consisting of triethylamine, diisopropylamine, tetramethyl ethylenediamine, pyridine, tetrabutylammonium bromide, benzyltrimethylammonium chloride, KOH, K₂CO₃ and a mixture thereof, and an organic solvent selected from the group consisting of chloroform, methylene chloride, tetrahydrofuran, N-methylpyrrolidone, methylsulfoxide, N,N-dimethylacetamide, 1,4-dioxane, ethylalcohol, methylalcohol, benzene, ethylene glycol dimethyl ether, acetonitrile and a mixture thereof.

4. A polymerizable composition comprising the compound of claim 1 as a polymerizable monomer and a polymerization initiator.

5. The composition of claim 4 which further comprises an additional hydrocarbon monomer, or an oligomer or polymer thereof.

6. A polymer film prepared by coating the composition of claim 4 on a substrate, followed by heat- or photo-curing.

7. A molded product prepared by placing the composition of claim 4 in a mold, followed by heat- or photo-curing.
